(19) United States
(12) Patent Application Publication
(10) Pub. No.: US 2009/0242715 A1
(43) Pub. Date: Oct. 1, 2009

(54) SYSTEM AND METHOD FOR SECURING CLIP ASSEMBLY TO A STRUCTURE

(76) Inventors: JOHN M. KOSIDLO, White Lake TWP, MI (US); Kent S. Gimmy, Gallatin, TN (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/361,303

(22) Filed: Jan. 28, 2009

Related U.S. Application Data
(60) Provisional application No. 61/040,889, filed on Mar. 31, 2008.

(51) Int. Cl. B60R 21/16; A47B 96/06

(52) U.S. Cl. 248/231.81; 280/728.2

(57) ABSTRACT

A system for securing a structure to a panel includes a clip assembly. The clip assembly includes an engagement plate secured to at least one strap through at least one curved portion. A central opening is formed through the engagement plate, and at least one strap cavity is formed through the strap(s). At least one extension beam integrally connects to and extends from the strap(s). The extension beam(s) is perpendicular to the strap(s) and the engagement plate in an at-rest position. At least one beam cavity is formed through the extension beam(s). At least one tab is integrally connected to the extension beam(s) through at least one intermediate portion. The tab(s) includes at least one removal hole formed therethrough that is aligned with the strap cavity and a portion of the central opening when the clip assembly is in the at-rest position. The tab is configured to pass into the beam cavity when the clip assembly is urged into a panel hole.

### RELATED APPLICATIONS

This application relates to and claims priority benefits from U.S. Provisional Patent Application No. 61/040,889 entitled “Retention Clip and Method of Insertion Including a Tool for the User Thereof,” filed Mar. 31, 2008, which is hereby incorporated by reference in its entirety.

### FIELD OF EMBODIMENTS OF THE INVENTION

Embodiments of the present invention generally relate to clip assemblies, and more particularly, to clip assemblies that are particularly suited for securing an air bag to a frame within a vehicle.

### BACKGROUND

Retention clips are used in various applications to secure one item to a frame or structure. For example, retention clips are commonly used to secure an air bag assembly to a structure within a vehicle. A typical clip assembly is secured to the structure. However, the clip assembly is not easily serviced or removed. Often, a separate tool is used to pry the clip assembly from the structure. In the process, the clip assembly is often damaged or otherwise rendered inoperable for future use. Further, in the process of removing the clip assembly from the structure, a portion of the clip assembly may snag a portion of the structure, thereby causing damage to the structure itself.

### SUMMARY OF EMBODIMENTS OF THE INVENTION

Certain embodiments of the present invention provide a system for securing a structure, such as an airbag assembly, to a panel, such as a vehicle frame panel. The system includes a clip assembly, which may be formed from a single piece of metal. That is, the clip assembly may be formed from a single blank of metal cut from a metal sheet and bent and crimped into shape.

The clip assembly may include an engagement or top plate secured to first and second straps through first and second curved portions, respectively. A central opening is formed through the engagement plate. A strap cavity is formed through each of the first and second straps, respectively.

The clip assembly may also include first and second extension beams integrally connected to and extending from the first and second straps, respectively. The first and second beams are perpendicular to the first and second straps and the engagement plate when the clip assembly is in an at-rest position (i.e., when the clip assembly is not positioned within the panel or when the clip assembly is fully inserted into the panel). A beam cavity is formed through each of the first and second beams, respectively.

First and second tabs integrally connect to the first and second beams, respectively, through intermediate portions. Each tab includes a removal hole formed therethrough. Each removal hole is aligned with one of the strap cavities and a portion of the central opening when the clip assembly is in the at-rest position so that a tool may engage the removal holes through the central opening. The first and second tabs are each configured to pass into one of the beam cavities when the clip assembly is urged into a panel hole. The removal holes are configured to be engaged by a tool to squeeze the tabs toward one another in order to safely remove the clip assembly from the panel hole

Each extension beam may include a beveled leg angled toward a central axis of the clip assembly. Each intermediate portion may include a curved member integrally connected between one of the beveled legs and an angled beam, which may, in turn, be connected to an upstanding beam, which may, in turn, be integrally connected to one of the first and second tabs. The curved members flex when the clip assembly is inserted into the panel hole.

Each of intermediate portions may include a curved member that has a constant radius through a sweep of 180°. The curved member, in turn, may be integrally connected to an upstanding wall that is parallel with the first and second beams when the clip assembly is in the at-rest position. The upstanding wall, in turn, may be integrally connected to an angled beam, which, in turn, may integrally connect to one of the first or second tabs. The angled beams may inwardly pivot about a union of the angled beams and the upstanding walls when the clip assembly is urged into the panel hole.

The system may also include a clip insertion tool configured to secure the clip assembly to the panel. The clip insertion tool may include an engagement mount configured to engage the engagement plate and an orienting stud extending from the engagement mount. The orienting stud acts to align and orient the clip assembly on the engagement mount.

The clip insertion tool may also include at least one sensor on the engagement mount. The sensor(s) detects abutment with a surface of the panel in order to determine that the clip assembly is fully inserted into the panel.

The clip insertion tool may also include at least one contact indicating member that provides an indication when the clip assembly is fully inserted into the panel. The contact indicating member may be a light emitting diode that lights up when full insertion is achieved.

### BRIEF DESCRIPTION OF SEVERAL VIEWS OF THE DRAWINGS

FIG. 1 illustrates an isometric top view of a clip assembly, according to an embodiment of the present invention.

FIG. 2 illustrates a front view of a clip assembly, according to an embodiment of the present invention.

FIG. 3 illustrates a top view of a blank used to form a clip assembly, according to an embodiment of the present invention.

FIG. 4 illustrates a top view of a clip assembly, according to an embodiment of the present invention.

FIG. 5 illustrates an isometric view of a clip assembly prior to insertion into a panel, according to an embodiment of the present invention.

FIG. 6 illustrates an isometric view of a clip assembly being inserted into a panel, according to an embodiment of the present invention.

FIG. 7 illustrates an isometric view of a clip assembly passing into a panel, according to an embodiment of the present invention.

FIG. 8 illustrates an isometric view of a clip assembly at a point of maximum deflection within a panel, according to an embodiment of the present invention.

FIG. 9 illustrates an isometric view of a clip assembly fully inserted into a panel, according to an embodiment of the present invention.

FIG. 10 illustrates a front view of a clip assembly fully inserted into a panel, according to an embodiment of the present invention.

FIG. 11 illustrates a top view of a clip assembly fully inserted into a panel, according to an embodiment of the present invention.

FIG. 12 illustrates an isometric side view of a clip insertion tool, according to an embodiment of the present invention.

FIG. 13 illustrates an isometric front view of a clip insertion tool, according to an embodiment of the present invention.

FIG. 14 illustrates an isometric view of a clip assembly being positioned on an operative end of a clip insertion tool, according to an embodiment of the present invention.

FIG. 15 illustrates an isometric top view of a clip assembly, according to an embodiment of the present invention.

FIG. 16 illustrates a front view of a clip assembly, according to an embodiment of the present invention.

FIG. 17 illustrates a cross-sectional view of a clip assembly being inserted into a panel, according to an embodiment of the present invention.

FIG. 18 illustrates a cross-sectional view of a clip assembly fully inserted into a panel, according to an embodiment of the present invention.

FIG. 19 illustrates a top view of a clip assembly fully inserted into a panel, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

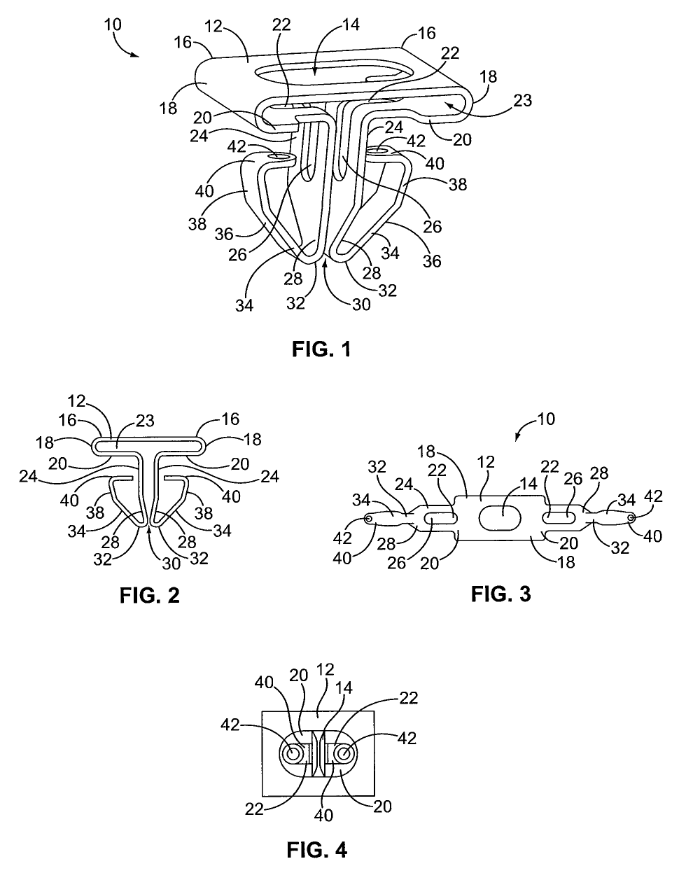

FIGS. 1 and 2 illustrate isometric top and front views, respectively, of a clip assembly 10, according to an embodiment of the present invention. Referring to FIGS. 1 and 2, the clip assembly 10 includes an engagement or top plate 12 having a central opening 14 formed therethrough. Curved walls 18 integrally connect to ends 16 of the top plate 12. The curved walls 18 are bent so that they integrally connect to straps 20 that are generally parallel with an underside of the top plate 12. A central cavity 22 is formed within the straps 20. The curved walls 18 provide a clearance area 23 between the top plate 12 and the straps 20.

The straps 20 integrally connect to downwardly extending beams 24. The beams 24 are generally perpendicular to the straps 20 and the top plate 12. The central cavity 22 formed in each strap 20 connects to a central cavity 26 formed in the beams 24. The cavities 22 and 26 provide greater flexibility to the straps 20 and beams 24. As shown in FIG. 1, the cavities 26 extend roughly half way down the length of the beams 24. However, the cavities 22 and 26 may be longer or shorter than those shown. For example, if the straps 20 and beams 24 are to be more rigid, the cavities 22 and 26 may be reduced or shortened, depending on a particular application. Conversely, if more flexibility is desired, the cavities 22 and 26 may be lengthened and/or widened.

The beams 24 include beveled legs 28 that taper with increased distance from the mid-sections of the beams 24. The beveled legs 28 angle toward a central axis x of the clip assembly 10 within a gap 30 formed between the beams 24. Distal tips 32 of the legs 28 angle toward another almost forming a point. However, the tabs 28 do not touch one another when the clip assembly 10 is in an at-rest position.

The distal tips 32 integrally connect to outwardly (with respect to the gap 30) directed curved beams 34 that integrally connect to angled beams 36 that angle away from one another. The angled beams 36, in turn, integrally connect to upstanding beams 38 that are closer to being parallel with the beams 24 than the angled beams 36. Tabs 40 integrally connect to the beams 38 and are generally parallel with the top plate 12 and the straps 20. Holes 42 are formed through the tabs 40. The holes 42 are accessible through the cavities 22 and the central opening 14. That is, the central axes of each hole 42 is axially aligned with a portion of a cavity 22 and a portion of the central opening 14. The tabs 40 are sized to be able to pass into the central cavities 26 formed in the beams 24 when the tabs 40 are urged toward one another.

As shown in FIG. 1, the beveled legs 28, curved beams 34 and angled beams 36 form a lead-in feature or nose configured to allow the clip assembly 10 to pass into an opening formed through a panel.

FIG. 3 illustrates a top view of a blank used to form the clip assembly 10, according to an embodiment of the present invention. The clip assembly 10 may be formed from a single piece of metal. The blank is bent and crimped to form the clip assembly 10 shown in FIG. 1.

FIG. 4 illustrates a top view of the clip assembly 10. As shown in FIG. 4, the holes 42 formed through the tabs 40 are exposed through the cavities 22 formed through the straps 20 and the central opening 14 formed through the top plate 12.

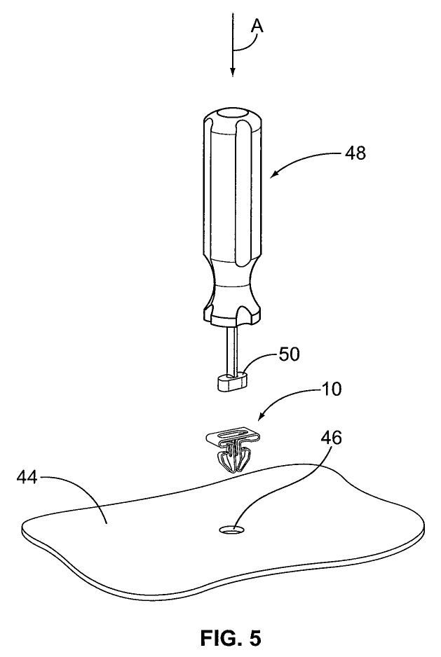

FIG. 5 illustrates an isometric view of the clip assembly 10 prior to insertion into a panel 44, according to an embodiment of the present invention. Referring to FIGS. 1-5, the lead-in feature formed by the beveled legs 28 and beams 34 and 36 of the clip assembly 10 is aligned over a hole 46 formed through the panel 44. A tool 48 is aligned over the clip assembly 10 such that an operative end 50 of the tool 48 is aligned over the central opening 14 formed through the top wall 12. The tool 48 is urged into the clip assembly 10 such that the operative end 50 passes into the beams 24 via the cavities 26. The operative end 50 rests on lower edges of the beams 24 that define the cavities 26. The tool 48 is then used to urge the clip assembly 10 into the hole 46 in the direction of arrow A. Optionally, various other tools may be used to urge the clip assembly 10 into the panel 44.

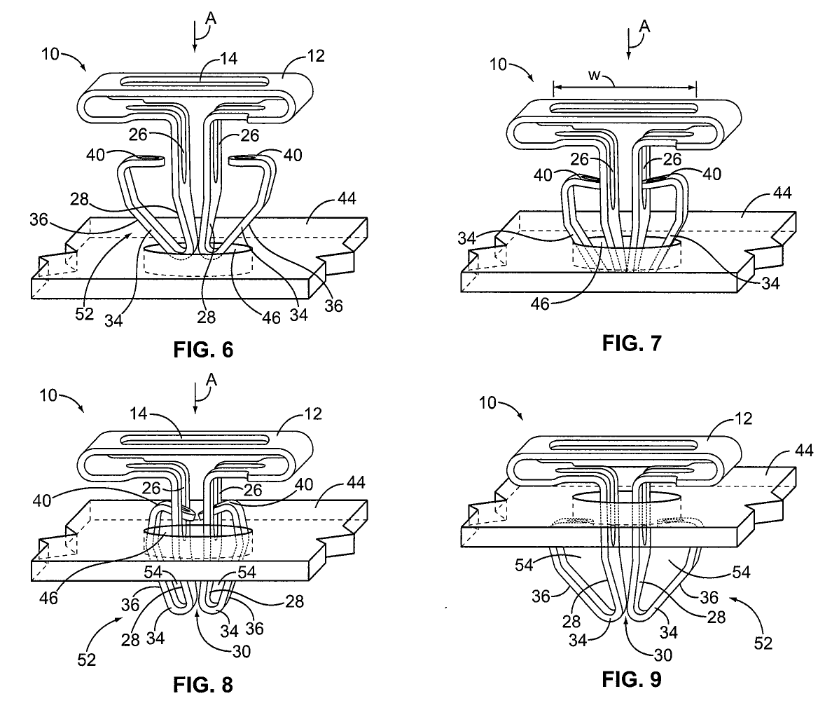

FIG. 6 illustrates an isometric view of the clip assembly 10 being inserted into the panel 44. For the sake of clarity, the tool 48 shown in FIG. 5 is not shown in FIG. 6. However, it is understood that the operative end 50 of the tool 48 may be positioned within the cavities 26. As noted above, the beveled legs 28 and beams 34 and 36 form a lead-in feature or nose 52, which is aligned with and inserted into the hole 46 of the panel 44. In order to secure the clip assembly 10 to the panel 44, the clip assembly 10 is urged into the hole 46 in the direction of arrow A.

FIG. 7 illustrates an isometric view of the clip assembly passing into the panel 44. Because the width w of the lead in feature is greater than the hole 46, as the clip assembly 10 is urged into the hole, the flexible beams 34 compress toward another, as they slide over edges defining the hole 46. Consequently, the tabs 40 are squeezed toward one another. As shown in FIG. 7, the tabs 40 pass into the cavities 26 as the clip assembly 10 is urged into the hole 46 of the panel 44.

FIG. 8 illustrates an isometric view of the clip assembly 10 at a point of maximum deflection within the panel 44. In this position, when the widest portion of the nose 52 is within the hole 46, the curved beams 34 cause the beams 36 to flex toward the beveled legs 28, thereby decreasing the spaces 54 between the beams 36 and the legs 28. Also, the tabs 40 are squeezed toward one another through the cavities 26 such that they may even touch one another. As the clip assembly 10 is further urged in the direction of arrow A, the nose 52 begins to expand so that the spaces 54 increase and the tabs 40 recede away from one another.

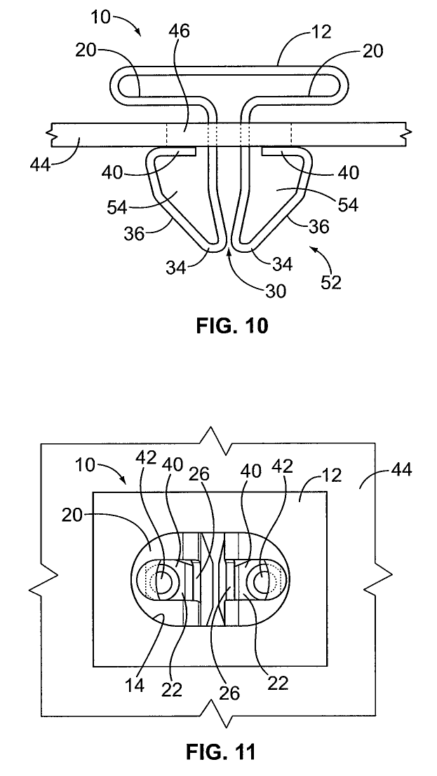

FIG. 9 illustrates an isometric view of the clip assembly 10 fully inserted into the panel 44. FIG. 10 illustrates a front view of the clip assembly 10 fully inserted into the panel 44. Referring to FIGS. 9-10, when the clip assembly 10 is urged into the panel 44 such that the tabs 40 pass through the hole 46, the curved beams 34 cause the beams 34 to flex to expand back to their at-rest positions. The tabs 40 then abut the underside of the panel 44. As shown in FIG. 10, the tabs 40 are generally flush with an underside of the panel 44. However, at least portions of the holes 42 (hidden from view) are exposed through the cavities 22 (hidden from view) formed through the straps 20

FIG. 11 illustrates a top view of the clip assembly 10 fully inserted into a panel 44. Portions of the holes 42 formed through the tabs 40 are exposed through the cavities 22 formed through the straps 20 and the central opening 14 formed through the top plate 12. In order to remove the clip assembly 10 from the panel 44, a tool, such as needle nosed pliers may be used. Distal ends of the prongs of the pliers are inserted into the holes 42. The prongs are then moved toward one another, thereby causing the tabs 40 to follow. The tabs 40 then pass into the cavities 26, such as shown in FIG. 8. In this position, the width of the nose 52 (shown in FIGS. 8, for example) is less than the width or diameter of the hole 46 (shown in FIGS. 6-10) formed through the panel 44. Thus, the clip assembly 10 may be safely and easily removed from the panel without damaging the clip assembly 10 or the panel 44.

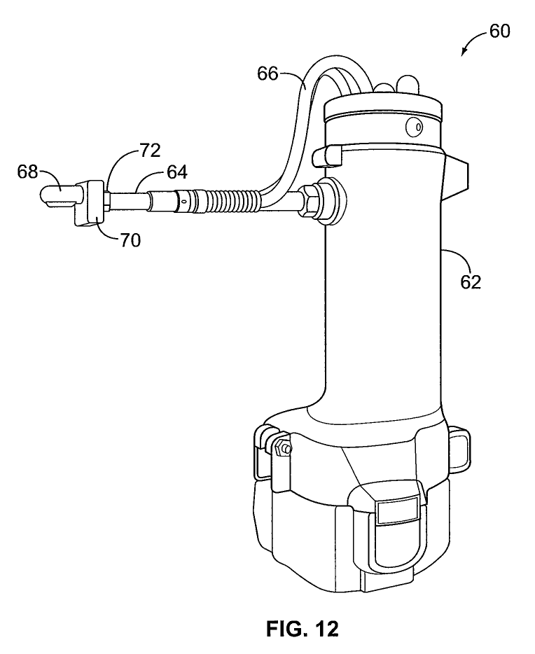

FIG. 12 illustrates an isometric side view of a clip insertion tool 60, according to an embodiment of the present invention. The tool 60 includes a main body 62 and a clip inserting arm 64. A pair of light-emitting diodes (LEDs) 63 are located on the main body 62. Instead, of LEDs, various other indicating members, such as regular lights, digital displays or the like may be used. Pneumatic tubes and electrical wires connect to the arm 64 through the main body 62 by way of flexible tubing 66. An orienting stud 68 extends from a clip engaging mount 70 located at a distal end 72 of the arm 64.

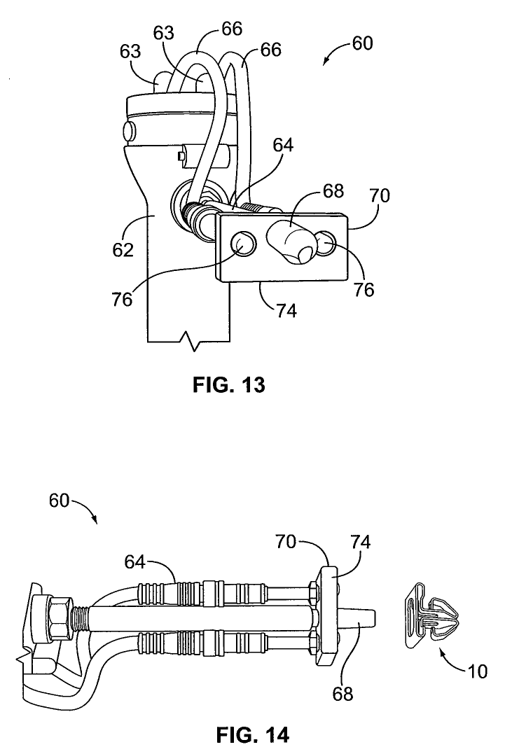

FIG. 13 illustrates an isometric front view of the clip insertion tool 60, according to an embodiment of the present invention. The clip engaging mount 70 includes a plate 74 configured to engage the top plate 12 of the clip assembly 10 (shown in FIGS. 1-11). The orienting stud 68 extends outwardly from the mount 70 along a center vertical axis of the mount 70. Sensors 76 are located on the plate 74 on either side of the stud 68. The sensors 76 are configured to detect contact with metal. That is, as the sensors 76 sensors contact a metal surface, the sensors 76 send a signal indicating such contact.

FIG. 14 illustrates an isometric view of the clip assembly being positioned on an operative end of a clip insertion tool 60, according to an embodiment of the present invention. Referring to FIGS. 1-14, the clip assembly 10 is positioned on the mount 70 such that the orienting stud 68 passes through the central opening 14 of the top plate 12 and is positioned between the downwardly extending beams 24. In this position, the sensors 76 are positioned over the central opening 14, while the top plate 12 is otherwise flush with the plate 74. The tool 60 is then used to drive the clip assembly 10 into the panel 44, as described above.

When the tool 60 is operational, one LED 63 may signal that the clip assembly 10 is not fully inserted into the panel 44. That is, if the sensors 76 do not contact the metal of the panel 44, the clip assembly 10 is not fully inserted. In this state, only one LED 63 may emit light. However, when the sensors 76 contact the metal of the panel 44 (by passing through the central opening 14 of the top plate 12 of the clip assembly 10 and contact the top surface of the panel 44), then the clip assembly 10 is fully inserted. The sensors 76 detect this contact and relay a signal to a processor (not shown) within the tool 60 indicating such contact. The processor then sends a signal for both LEDs 63 to emit light. Full insertion of the clip assembly 10 is indicated when both LEDs 63 are lit. Alternatively, both lights 63 may not emit light until the clip assembly 10 is fully inserted. Optionally, the tool 60 may include only one LED 63 that emits light when the clip assembly 10 is fully inserted. In this case, the LED 63 only emits light when the clip assembly is fully inserted.

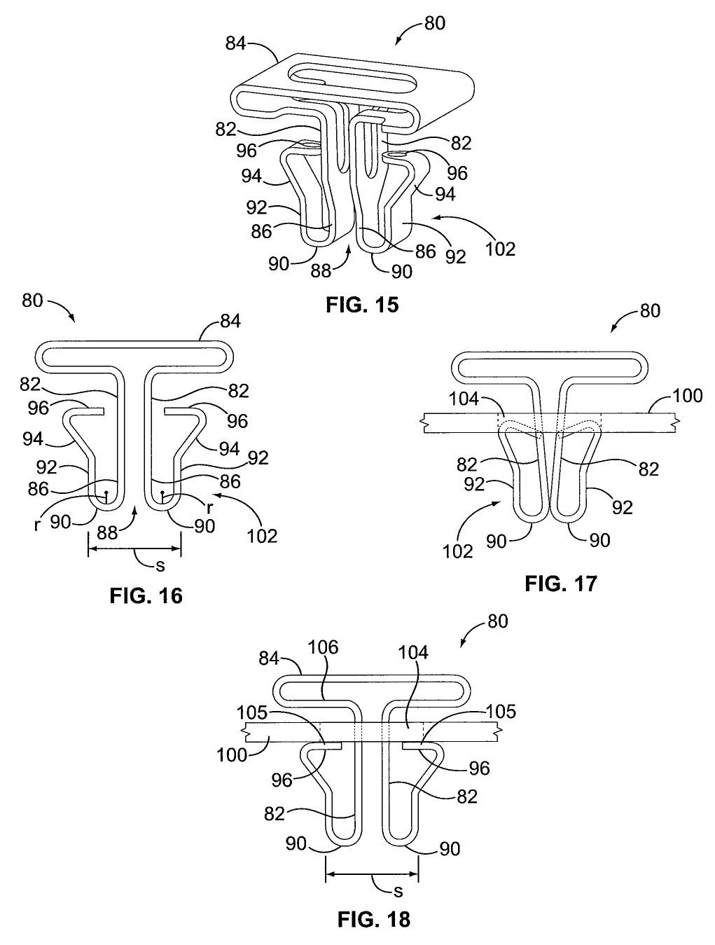

FIGS. 15 and 16 illustrate isometric top and front views, respectively, of a clip assembly 80, according to an embodiment of the present invention. Referring to FIGS. 15 and 16, the clip assembly 80 is similar to the clip assembly 10 (shown in FIGS. 1-11), but with some differences with respect to the lead-in feature. The downwardly extending beams 82 are parallel with one another and perpendicular to the top plate 84. The legs 86 are aligned in the same plane with the upper portions of the beams 82. As such, in the at-rest position, the central gap 88 between the beams 82 is uniform throughout the length of the beams 82. That is, the gap 88 does not taper toward an apex. The radius r of each curved beam 90 is greater than those of the curved beams 34 (shown in FIG. 1, for example). Further, the curved beams 90 sweep through an angle of 180° and integrally connect to straight upstanding beams 92 that are generally parallel with the beams 82. The increased radii and larger angular sweep of the curved beams 90 provides increased strength to the curved beams 90, while also maintaining flexibility. As shown in FIG. 17 below, the curved beams 90 do not compress (that is, the gap between a beam 82 and beam 92 does not decrease) when the tabs 96 deflect toward one another. Thus, the curved beams 90 are not susceptible to breaking, snapping or otherwise wearing down over time. The upstanding beams 92, in turn, integrally connect to angled beams 94, which, in turn, integrally connect to the tabs 96.

The curved beams 90 and straight, upstanding beams 92 allow for easier insertion into the hole. Further, the straight beams 92 allow for the nose 102 to quickly and easily move into a hole formed through a panel. For example, the span s between outer surfaces of the straight beams 92 may be the same as (or slightly less than) the diameter of a hole into which the nose 102 is positioned. However, the span of the angled beams 94 increases with increased distance from the straight beams 92 so that it is greater than the diameter of the hole of the panel. As such, as the angled beams 94 engage edges of the hole, the nose 102 compresses, such that the tabs 96 pass into cavities formed through the beams 82 and the curved beams 90 move toward one another.

FIG. 17 illustrates a cross-sectional view of the clip assembly 80 being inserted into a panel 100, according to an embodiment of the present invention. As the nose 102 passes through the hole 104 formed through the panel 100, the curved beams 90 are squeezed toward one another, inner surfaces of the curved beams may abut one another at the point of maximum deflection through the hole 104. During this movement, the angled beams 94 inwardly pivot about a union of the angled beams 94 and straight beams 94, or upstanding walls, when said clip assembly passes through the hole 104 of the panel 100 while the angled beams 94 are in contact with the edges of the panel 100 that define the hole 104.

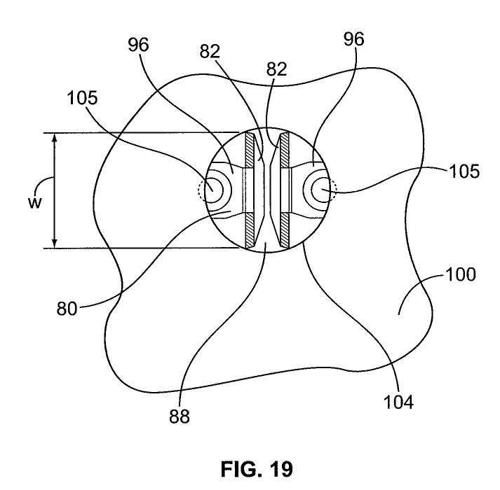

FIG. 18 illustrates a cross-sectional view of the clip assembly 80 fully inserted into the panel 100. Similar to the clip assembly 10 (shown in FIGS. 1-11), in the fully-inserted position, the tabs 96 are flush with a lower surface of the panel 100. At least portions of the holes 105 formed through the tabs 96 are exposed through the central opening formed through the top plate 84, the cavities formed through the straps 106 and the hole 104 formed through the panel 100. As discussed with respect to FIG. 19, portions of the beams 82 abut into edges of the panel 100 that define the hole 104, thereby ensuring that the tabs 96 remain flush against an underside of the panel 100 and the straps 106 are separated from a top surface of the panel 100. Thus, the clip assembly 80 is prevented from floating with respect to the panel 100.

FIG. 19 illustrates a top view of the clip assembly 80 fully inserted into the panel 100. For the sake of clarity, the top plate 84 is not shown. As shown in FIG. 19, the width w of the beams 82 is slightly less than the diameter of the hole 104. As such, the beams 82 provide an interference fit within the hole 104 of the panel 100, thereby ensuring that the tabs 94 remain flush with the surface of the underside of the panel 100.

Portions of the holes 105 of the tabs 96 are exposed and accessible. Thus, a tool, such as needles nose pliers, may engage the holes to remove the clip assembly 80 from the panel, similar to that described above with respect to the clip assembly 10.

Embodiments of the present invention provide a clip assembly that may be easily secured to a structure. Further, embodiments of the present invention provide a clip assembly that may be easily removed from the structure without damaging the clip assembly or the structure. Thus, the clip assembly may be removed for servicing and reused.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A system for securing a structure to a panel, the system comprising a clip assembly comprising:
an engagement plate secured to first and second straps through first and second curved portions, respectively, wherein a central opening is formed through said engagement plate, wherein a strap cavity is formed through each of said first and second straps, respectively;
first and second beams integrally connected to and extending from said first and second straps, respectively, said first and second beams being perpendicular to said first and second straps and said engagement plate when said clip assembly is in an at-rest position, wherein a beam cavity is formed through each of said first and second beams, respectively; and
first and second tabs integrally connected to said first and second beams, respectively, through intermediate portions, each of said tabs comprising a removal hole formed therethrough, each of said removal holes being aligned with one of said strap cavities and a portion of said central opening when the clip assembly is in the at-rest position so that a tool may engage said removal holes through said central opening,
wherein said first and second tabs are each configured to pass into one of said beam cavities when said clip assembly is urged into a panel hole.

2. The system of claim 1, wherein each of said first and second beams comprises a beveled leg angled toward a central axis of said clip assembly, and wherein each of said intermediate portions comprises a curved member integrally connected between one of said beveled legs and an angled beam, which is in turn connected to an upstanding beam, which is in turn integrally connected to one of said first and second tabs.

3. The system of claim 2, wherein said curved members flex when said clip assembly is inserted into the panel hole.

4. The system of claim 1, wherein each of said intermediate portions comprises a curved member that has a constant radius through a sweep of 180°, said curved member, in turn, being integrally connected to an upstanding wall that is parallel with said first and second beams when said clip assembly is in the at-rest position, said upstanding wall, in turn, being integrally connected to an angled beam, which, in turn, integrally connects to one of said first and second tabs.

5. The system of claim 4, wherein said angled beams inwardly pivot about a union of said angled beams and said upstanding walls when said clip assembly is urged into the panel hole.

6. The system of claim 1, wherein said removal holes are configured to be engaged by a tool to squeeze the tabs toward one another in order to safely remove said clip assembly from the panel hole.

7. The system of claim 1, wherein said clip assembly is formed from a single blank of metal.

8. The system of claim 1, comprising a clip insertion tool configured to secure said clip assembly to the panel, said clip insertion tool comprising an engagement mount configured to engage said engagement plate and an orienting stud extending from said engagement mount, said orienting stud acting to align and orient said clip assembly on said engagement mount.

9. The system of claim 8, wherein said clip insertion tool comprises at least one sensor on said engagement mount, said at least one sensor detecting abutment with a surface of the panel in order to determine that said clip assembly is fully inserted into the panel.

10. The system of claim 9, wherein said clip insertion tool comprises at least one contact indicating member that provides an indication when said clip assembly is fully inserted into the panel.

11. The system of claim 10, wherein said at least one contact indicating member is a light emitting diode.

12. A system for securing a structure to a panel, the system comprising a clip assembly comprising:
an engagement plate secured to at least one strap through at least one curved portion, wherein a central opening is formed through said engagement plate, wherein at least one strap cavity is formed through said at least one strap;
at least one extension beam integrally connected to and extending from said at least one strap, said at least one extension beam being perpendicular to said at least one strap and said engagement plate when said clip assembly is in an at-rest position, wherein at least one beam cavity is formed through said at least one extension beam; and
at least one tab integrally connected to at least one extension beam through at least one intermediate portion, said at least one tab comprising at least one removal hole formed therethrough, said at least one removal hole being aligned with said at least one strap cavity and a portion of said central opening when the clip assembly is in the at-rest position so that a tool may engage said at least one removal hole through said central opening,
wherein said at least one tab is configured to pass into said at least one beam cavity when said clip assembly is urged into a panel hole.

13. The system of claim 12, wherein said at least one extension beam comprises a beveled leg angled toward a central axis of said clip assembly, and wherein said at least one intermediate portion comprises a curved member integrally connected between one of said beveled legs and an angled beam, which is in turn connected to an upstanding beam, which is in turn integrally connected to said at least one tab.

14. The system of claim 13, wherein said curved member flexes when said clip assembly is inserted into the panel hole.

15. The system of claim 12, wherein said at least one intermediate portion comprises a curved member that has a constant radius through a sweep of 180°, said curved member, in turn, being integrally connected to an upstanding wall that is parallel with said at least one extension beam when said clip assembly is in the at-rest position, said upstanding wall, in turn, being integrally connected to an angled beam, which, in turn, integrally connects to said at least one tab.

16. The system of claim 15, wherein said angled beam inwardly pivots about a union of said angled beam and said upstanding wall when said clip assembly is urged into the panel hole.

17. The system of claim 12, wherein said at least one removal hole is configured to be engaged by a tool to move said at least one tab toward a central axis of said clip assembly in order to safely remove said clip assembly from the panel hole.

18. The system of claim 12, wherein said clip assembly is formed from a single blank of metal.

19. The system of claim 12, comprising a clip insertion tool configured to secure said clip assembly to the panel, said clip insertion tool comprising:
an engagement mount configured to engage said engagement plate;
an orienting stud extending from said engagement mount, said orienting stud acting to align and orient said clip assembly on said engagement mount;
at least one sensor on said engagement mount, said at least one sensor detecting abutment with a surface of the panel in order to determine that said clip assembly is fully inserted into the panel; and
at least one light emitting diode that indicates when said clip assembly is fully inserted to the panel.

20. A system for securing a structure to a panel, the system comprising a clip assembly formed from a single blank of metal, said clip assembly comprising:
an engagement plate secured to first and second straps through first and second curved portions, respectively, wherein a central opening is formed through said engagement plate, wherein a strap cavity is formed through each of said first and second straps, respectively;
first and second beams integrally connected to and extending from said first and second straps, respectively, said first and second beams being perpendicular to said first and second straps and said engagement plate when said clip assembly is in an at-rest position, wherein a beam cavity is formed through each of said first and second beams, respectively; and
first and second tabs integrally connected to said first and second beams, respectively, through intermediate portions, each of said tabs comprising a removal hole formed therethrough, each of said removal holes being aligned with one of said strap cavities and a portion of said central opening when the clip assembly is in the at-rest position so that a tool may engage said removal holes through said central opening, said removal holes configured to be engaged by a tool to squeeze the tabs toward one another in order to safely remove said clip assembly from the panel hole
wherein said first and second tabs are each configured to pass into one of said beam cavities when said clip assembly is urged into a panel hole.

21. The system of claim 20, comprising a clip insertion tool configured to secure said clip assembly to the panel, said clip insertion tool comprising:
an engagement mount configured to engage said engagement plate;
an orienting stud extending from said engagement mount, said orienting stud acting to align and orient said clip assembly on said engagement mount;
at least one sensor on said engagement mount, said at least one sensor detecting abutment with a surface of the panel in order to determine that said clip assembly is fully inserted into the panel; and
at least one light emitting diode that indicates when said clip assembly is fully inserted to the panel.
